(19) United States
(12) Patent Application Publication
(10) Pub. No.: US 2025/0333059 A1
(43) Pub. Date: Oct. 30, 2025

(54) VEHICLE CONTROL DEVICE, VEHICLE CONTROL METHOD, AND NON-TRANSITORY RECORDING MEDIUM

(71) Applicant: TOYOTA JIDOSHA KABUSHIKI KAISHA, Toyota-shi Aichi-ken (JP)

(72) Inventors: Takahiro Furukawa, Nagoya-shi Aichi-ken (JP); Masao Ueyama, Kawasaki-shi Kanagawa-ken (JP); Shuntaro Shinohara, Edogawa-ku Tokyo-to (JP)

(73) Assignee: TOYOTA JIDOSHA KABUSHIKI KAISHA, Toyota-shi Aichi-ken (JP)

(21) Appl. No.: 19/185,486

(22) Filed: Apr. 22, 2025

(30) Foreign Application Priority Data
Apr. 30, 2024 (JP) 2024-073985

(51) Int. Cl. B60W 30/16; B60W 50/00

(52) U.S. Cl. CPC B60W 30/162; B60W 50/0098; B60W 2420/408

(57) ABSTRACT

A vehicle control device infers a limit detection distance which is a maximum value of a distance from a surrounding situation sensor detectable by the surrounding situation sensor, the surrounding situation sensor being mounted on a host vehicle. The processor infers the limit detection distance of the surrounding situation sensor based on sensor data of the surrounding situation sensor by using a machine learning model obtained by performing learning using teacher data which is a data set of sensor data of a learning surrounding situation sensor mounted on a learning vehicle and a label indicating the limit detection distance of the learning surrounding situation sensor when the sensor data of the learning surrounding situation sensor is obtained.

### CROSS-REFERENCE TO RELATED APPLICATIONS

This application claims priority to Japanese Patent Application No. 2024-073985 filed Apr. 30, 2024, the entire contents of which are herein incorporated by reference.

### FIELD

The present disclosure relates to vehicle control device, vehicle control method, and non-transitory recording medium.

### BACKGROUND

PTL 1 (J P-A-2004-230910) discloses a technique in which a vehicle-to-vehicle distance warning device provided with a rainfall amount detecting means for detecting the size of the amount of rainfall changes the setting of the vehicle-to-vehicle distance warning and ACC in accordance with the size of the rainfall and notifies the driver.

In the technique described in PTL 1, when the amount of rainfall exceeds a predetermined amount, control for reducing the speed of the host vehicle is performed and the distance for warning to the object in front of the host vehicle is set to be small. However, for example, at the time of bad weather due to dense fog, bad weather due to snowfall (snowfall of dry snow) or the like (specifically, when the in-vehicle sensor cannot detect the object in front of the host vehicle), it is impossible to appropriately control the host vehicle.

### SUMMARY

In view of the above-described points, it is an object of the present disclosure to provide vehicle control device, vehicle control method, and non-transitory recording medium which can suppress a possibility that control of a host vehicle is inappropriately performed when a limit detection distance of a surrounding situation sensor mounted on the host vehicle is short (specifically, when the surrounding situation sensor cannot detect a preceding vehicle of the host vehicle).

(1) One aspect of the present disclosure is a vehicle control device including a processor configured to infer a limit detection distance which is a maximum value of a distance from a surrounding situation sensor detectable by the surrounding situation sensor, the surrounding situation sensor being mounted on a host vehicle, wherein the processor is configured to infer the limit detection distance of the surrounding situation sensor based on sensor data of the surrounding situation sensor by using a machine learning model obtained by performing learning using teacher data which is a data set of sensor data of a learning surrounding situation sensor mounted on a learning vehicle and a label indicating the limit detection distance of the learning surrounding situation sensor when the sensor data of the learning surrounding situation sensor is obtained.

(2) In the vehicle control device of the aspect (1), a distance between the learning vehicle and a preceding vehicle of the learning vehicle detected by a radar mounted on the learning vehicle when a state switches between a state in which the preceding vehicle can be detected based on the sensor data of the learning surrounding situation sensor and a state in which the preceding vehicle cannot be detected based on the sensor data of the learning surrounding situation sensor may be used as the limit detection distance of the learning surrounding situation sensor.

(3) In the vehicle control device of the aspect (1) or (2), the processor may be configured to set maximum speed limit of the host vehicle while performing driving assistance of the host vehicle, the processor may be configured to assume that the distance between the preceding vehicle of the host vehicle and the host vehicle is approximately equal to the limit detection distance of the surrounding situation sensor and set a speed at which the host vehicle can follow the preceding vehicle as the maximum speed limit when the limit detection distance of the surrounding situation sensor is less than or equal to a threshold value.

(4) Another aspect of the present disclosure is a vehicle control method including inferring a limit detection distance which is a maximum value of a distance from a surrounding situation sensor detectable by the surrounding situation sensor, the surrounding situation sensor being mounted on a host vehicle, wherein the limit detection distance of the surrounding situation sensor is inferred based on sensor data of the surrounding situation sensor by using a machine learning model obtained by performing learning using teacher data which is a data set of sensor data of a learning surrounding situation sensor mounted on a learning vehicle and a label indicating the limit detection distance of the learning surrounding situation sensor when the sensor data of the learning surrounding situation sensor is obtained.

(5) Another aspect of the present disclosure is a non-transitory recording medium having recorded thereon a computer program for causing a processor to perform a process comprising inferring a limit detection distance which is a maximum value of a distance from a surrounding situation sensor detectable by the surrounding situation sensor, the surrounding situation sensor being mounted on a host vehicle, wherein the limit detection distance of the surrounding situation sensor is inferred based on sensor data of the surrounding situation sensor by using a machine learning model obtained by performing learning using teacher data which is a data set of sensor data of a learning surrounding situation sensor mounted on a learning vehicle and a label indicating the limit detection distance of the learning surrounding situation sensor when the sensor data of the learning surrounding situation sensor is obtained.

According to the present disclosure, it is possible to suppress the possibility that the control of the host vehicle is inappropriately performed when the limit detection distance of the surrounding situation sensor mounted on the host vehicle is short.

### BRIEF DESCRIPTION OF DRAWINGS

FIG. 1 is a view showing an example of a host vehicle to which a vehicle control device of a first embodiment is applied.

FIG. 2 is a view showing an example of a learning vehicle used for obtaining a machine learning model used to infer a limit detection distance by an inference unit.

FIG. 3 is a flowchart for explaining an example of a process performed by a processor of the vehicle control device of the first embodiment when driving assistance (adaptive cruise control) of the host vehicle 1 is performed at the time of bad weather.

### DESCRIPTION OF EMBODIMENTS

Below, referring to the drawings, embodiments of vehicle control device, vehicle control method, and non-transitory recording medium of the present disclosure will be explained.

### First Embodiment

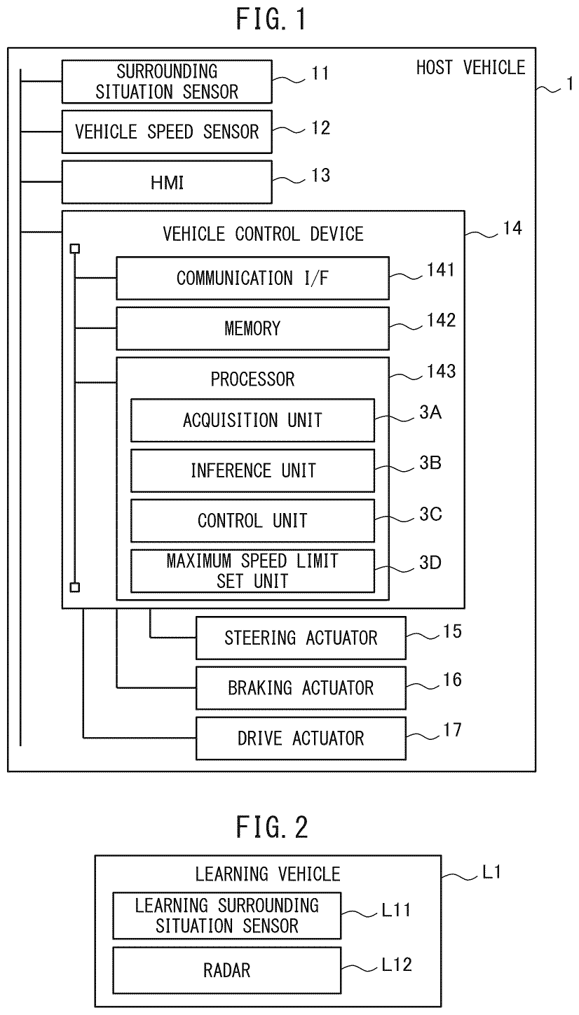

FIG. 1 is a view showing an example of a host vehicle 1 to which a vehicle control device 14 of a first embodiment is applied. In the example shown in FIG. 1, the host vehicle 1 includes surrounding situation sensor 11, vehicle speed sensor 12, HMI (Human Machine Interface) 13, vehicle control device 14, steering actuator 15, braking actuator 16, and drive actuator 17. The surrounding situation sensor 11 detects the surrounding situation (surrounding environment) of the host vehicle 1. The surrounding situation sensor 11 includes a camera which shoots the front of the host vehicle 1. The surrounding situation sensor 11 has a function of detecting a distance from the surrounding situation sensor 11 to a preceding vehicle or the like included in an image of the front of the host vehicle 1 shot by the camera (approximate distance between the host vehicle 1 and the preceding vehicle or the like) based on the image. The surrounding situation sensor 11 transmits sensor data (e.g., the image of the front of the host vehicle 1 shot by the camera, signal indicating the distance between the host vehicle 1 and the preceding vehicle, etc.) to the vehicle control device 14. The vehicle speed sensor 12 detects the speed of the host vehicle 1 and transmits the signal indicating the speed of the host vehicle 1 to the vehicle control device 14. The HMI 13 has a function of receiving various operations of a driver of the host vehicle 1 and transmitting signals indicating the operations of the driver of the host vehicle 1 to the vehicle control device 14.

The vehicle control device 14 is configured by a microcomputer which includes communication interface (I/F) 141, memory 142 and processor 143. The communication interface 141 includes an interface circuit for connecting the vehicle control device 14 to the surrounding situation sensor 11, the vehicle speed sensor 12, and the HMI 13. The memory 142 stores program used in a process performed by the processor 143 and various data. The processor 143 has function as an acquisition unit 3A, function as an inference unit 3B, function as a control unit 3C, and function as a maximum speed limit set unit 3D. The acquisition unit 3A acquires the sensor data transmitted from the surrounding situation sensor 11. The acquisition unit 3A acquires the signal indicating the speed of the host vehicle 1 transmitted from the vehicle speed sensor 12, the signals indicating the operations of the driver of the host vehicle 1 transmitted from the HMI 13, and the like.

There is a case where detection accuracy of the surrounding situation (surrounding environment) by the surrounding situation sensor 11 decreases, the surrounding situation sensor 11 cannot detect the preceding vehicle of the host vehicle 1 or the like, and the surrounding situation sensor 11 cannot detect the distance from the surrounding situation sensor 11 to the preceding vehicle or the like, due to bad weather (e.g. rainfall, snowfall, dense fog) or the like.

Therefore, in the example shown in FIG. 1, the inference unit 3B infers a limit detection distance (<the distance from the surrounding situation sensor 11 to the preceding vehicle or the like) which is a maximum value of the distance from the surrounding situation sensor 11 detectable by the surrounding situation sensor 11 at the time of bad weather and the like.

FIG. 2 is a view showing an example of a learning vehicle L1 used for obtaining a machine learning model used to infer the limit detection distance by the inference unit 3B. In the example shown in FIG. 2, the learning vehicle L1 includes learning surrounding situation sensor L11 and radar L12. The learning surrounding situation sensor L11 detects the surrounding situation of the learning vehicle L1. The learning surrounding situation sensor L11 includes a learning camera which shoots the front of the learning vehicle L1. The radar L12 detects the distance between the learning vehicle L1 and the preceding vehicle of the learning vehicle L1, for example, at the time of bad weather or the like.

For example, at the time of bad weather or the like, when the distance between the learning vehicle L1 and the preceding vehicle is short, the learning surrounding situation sensor L11 can detect the preceding vehicle based on the sensor data of the learning surrounding situation sensor L11 (specifically, image of the front of the learning vehicle L1 shot by the learning camera), but when the distance between the learning vehicle L1 and the preceding vehicle is long, the learning surrounding situation sensor L11 cannot detect the preceding vehicle based on the sensor data of the learning surrounding situation sensor L11 (image of the front of the learning vehicle L1 shot by the learning camera). That is, when the state in which the distance between the learning vehicle L1 and the preceding vehicle is short changes to the state in which the distance between the learning vehicle L1 and the preceding vehicle is long, the state switches from the state (detectable state) in which the learning surrounding situation sensor L11 can detect the preceding vehicle based on the image of the front of the learning vehicle L1 to the state (undetectable state) in which the learning surrounding situation sensor L11 cannot detect the preceding vehicle based on the image of the front of the learning vehicle L1. In addition, when the state changes from the state in which the distance between the learning vehicle L1 and the preceding vehicle is long to the state in which the distance between the learning vehicle L1 and the preceding vehicle is short, the state switches from the undetectable state to the detectable state.

In the example shown in FIG. 2, when the state switches between the detectable state and the undetectable state, the radar L12 detects the distance between the learning vehicle L1 and the preceding vehicle, and the distance between the learning vehicle L1 and the preceding vehicle at that time is used as the limit detection distance of the learning surrounding situation sensor L11.

In the example shown in FIG. 1 and FIG. 2, the inference unit 3B infers the limit detection distance of the surrounding situation sensor 11 (the maximum value of the distance from the surrounding situation sensor 11 detectable by the surrounding situation sensor 11) by using the limit detection distance of the learning surrounding situation sensor L11. Specifically, the inference unit 3B infers the limit detection distance of the surrounding situation sensor 11 based on the sensor data (image of the front of the host vehicle 1 shot by the camera) of the surrounding situation sensor 11 by using the machine learning model obtained by performing the learning using the data set (teacher data) of the image of the front of the learning vehicle L1 shot by the learning camera when the state switches between the detectable state and the undetectable state described above and the distance between the learning vehicle L1 and the preceding vehicle detected by the radar L 12 at that time (limit detection distance of the learning surrounding situation sensor L11). That is, the inference unit 3B infers the limit detection distance of the surrounding situation sensor 11 based on the sensor data of the surrounding situation sensor 11 by using the machine learning model obtained by performing the learning using the data set (teacher data) of the sensor data (image of the front of the learning vehicle L1 shot by the learning camera) of the learning surrounding situation sensor L11 and the a label indicating the limit detection distance of the learning surrounding situation sensor L11 when the sensor data of the learning surrounding situation sensor L11 is obtained.

The control unit 3C controls the steering actuator 15, the braking actuator 16, and the drive actuator 17 based on the signals transmitted from the HMI 13 or the like. Specifically, the control unit 3C has a function of performing driving assistance of the host vehicle 1. The driving assistance of the host vehicle 1 includes, for example, adaptive cruise control (ACC) and the like. The control unit 3C controls the braking actuator 16 and the drive actuator 17 based on the set speed of the host vehicle 1 and the distance between the host vehicle 1 and the preceding vehicle received by the HMI 13 and the sensor data (image of the front of the host vehicle 1 shot by the camera) of the surrounding condition sensor 11 while performing the adaptive cruise control. Specifically, the control unit 3C performs control to cause the host vehicle 1 to travel following the preceding vehicle while keeping the distance between the host vehicle 1 and the preceding vehicle constant during the adaptive cruise control.

There is a case where the limit detection distance of the surrounding condition sensor 11 is shorter than the distance between the host vehicle 1 and the preceding vehicle received by the HMI 13 at the time of bad weather or the like. There is a possibility that the distance between the host vehicle 1 and the preceding vehicle becomes inappropriate because the preceding vehicle is not detected by the surrounding condition sensor 11 although the preceding vehicle exists, or the adaptive cruise control is released by the control unit 3C or the like although the driver of the host vehicle 1 wishes the adaptive cruise control to continue, if the adaptive cruise control is performed in that case.

Therefore, in the example shown in FIG. 1 and FIG. 2, the maximum speed limit set unit 3D sets the maximum speed limit of the host vehicle 1 during the execution of the driving assistance of the host vehicle 1 (specifically, adaptive cruise control). Specifically, when the limit detection distance of the surrounding situation sensor 11 inferred by the inference unit 3B is equal to or less than a threshold value (specifically, when the preceding vehicle cannot be detected based on the sensor data of the surrounding situation sensor 11), the maximum speed limit set unit 3D assumes that the distance between the host vehicle 1 and the preceding vehicle is approximately equal to the limit detection distance inferred by the inference unit 3B and sets a speed at which the host vehicle 1 can safely follow the preceding vehicle as the maximum speed limit of the host vehicle 1 described above. Consequently, when the surrounding condition sensor 11 cannot detect the preceding vehicle during the execution of the adaptive cruise control, the control unit 3C does not cause the host vehicle 1 to travel at the set speed of the host vehicle 1 received by the HMI 13, but causes the host vehicle 1 to travel at the maximum speed limit of the host vehicle 1 set by the maximum speed limit set unit 3D (<set speed of the host vehicle 1 received by the HMI 13). Therefore, the execution of the adaptive cruise control can be continued safely (specifically, without the host vehicle 1 coming too close to the preceding vehicle) even in bad weather or the like.

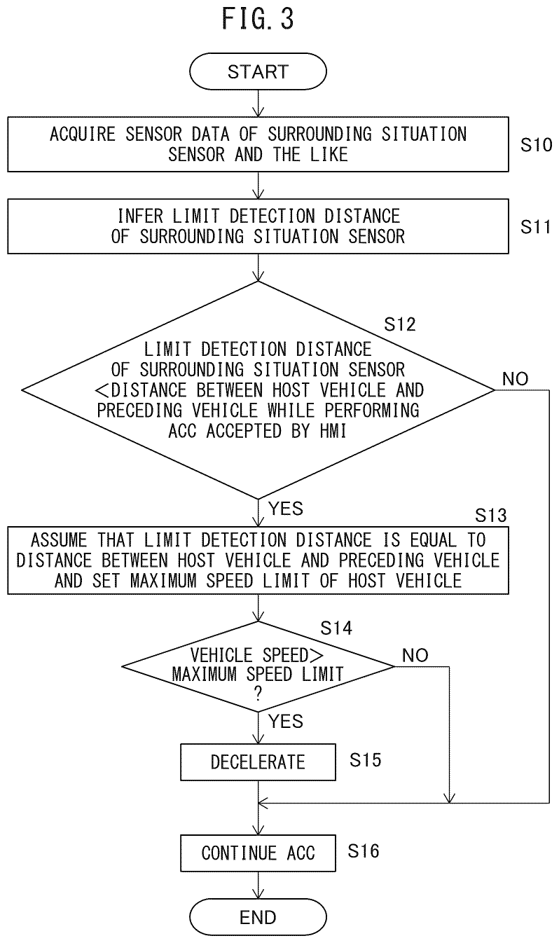

FIG. 3 is a flowchart for explaining an example of the process performed by the processor 143 of the vehicle control device 14 of the first embodiment when the driving assistance (adaptive cruise control) of the host vehicle 1 is performed at the time of bad weather.

In the example shown in FIG. 3, at step S10, the acquisition unit 3A acquires the sensor data (image of the front of the host vehicle 1 shot by the camera) of the surrounding situation sensor 11. The acquisition unit 3A acquires the signal indicating the speed of the host vehicle 1 detected by the vehicle speed sensor 12, the signals indicating the operations of the driver of the host vehicle 1 received by the HMI 13 (the set speed of the host vehicle 1 and the distance between the host vehicle 1 and the preceding vehicle during the execution of the adaptive cruise control), and the like.

At step S11, the inference unit 3B infers the limit detection distance of the surrounding situation sensor 11 based on the sensor data (image of the front of the host vehicle 1 shot by the camera) of the surrounding situation sensor 11 by using the machine learning model obtained by performing the learning using the data set (teacher data) of the sensor data (image of the front of the learning vehicle L1 shot by the learning camera) of the learning surrounding situation sensor L11 and the label indicating the limit detection distance of the learning surrounding situation sensor L11 when the sensor data of the learning surrounding situation sensor L11 is obtained.

At step S12, for example, the maximum speed limit set unit 3D determines whether the limit detection distance of the surrounding situation sensor 11 inferred at step S11 is shorter than the distance between the host vehicle 1 and the preceding vehicle during the execution of the adaptive cruise control acquired at step S10. When YES, it proceeds to step S13; when NO, it proceeds to step S16.

At step S13, the maximum speed limit set unit 3D assumes that the distance between the host vehicle 1 and the preceding vehicle is approximately equal to the limit detection distance of the surrounding situation sensor 11 inferred at step S11 and sets the speed at which the host vehicle 1 can safely follow the preceding vehicle as the maximum speed limit of the host vehicle 1 described above. More specifically, when the speed of the host vehicle 1 (set speed of the host vehicle 1 during the execution of the adaptive cruise control) acquired at step S10 is higher than the maximum speed limit of the host vehicle 1, the maximum speed limit set unit 3D changes the set speed of the host vehicle 1 during the execution of the adaptive cruise control to the maximum speed limit of the host vehicle 1 (decreases the set speed of the host vehicle 1 during the execution of the adaptive cruise control to the maximum speed limit of the host vehicle 1).

At step S14, for example, the control unit 3C determines whether the speed of the host vehicle 1 acquired at step S10 (speed of the host vehicle 1 detected by the vehicle speed sensor 12) is higher than the maximum speed limit of the host vehicle 1 set at step S13. When YES, it proceeds to step S15; when NO, it proceeds to step S16.

At step S15, the control unit 3C decelerates the host vehicle 1 until the speed of the host vehicle 1 detected by the vehicle speed sensor 12 is equal to the maximum speed limit of the host vehicle 1 set at step S13.

At step S16, the control unit 3C continues to perform the adaptive cruise control.

In the host vehicle 1 to which the vehicle control device 14 of the first embodiment is applied, it is possible to suppress the possibility that the control of the host vehicle 1 is inappropriately performed when the limit detection distance of the surrounding situation sensor 11 is short (when the surrounding situation sensor 11 cannot detect the preceding vehicle of the host vehicle 1 due to bad weather or the like).

### Second Embodiment

The host vehicle 1 to which the vehicle control device 14 of a second embodiment is applied is configured similarly to the vehicle 1 to which the vehicle control device 14 of the first embodiment shown in FIG. 1. As described above, the learning vehicle L1 used to obtain the machine learning model used for inference of the limit detection distance by the inference unit 3B of the vehicle control device 14 of the first embodiment includes the radar L12. On the other hand, the learning vehicle L1 used to obtain the machine learning model used for the inference of the limit detection distance by the inference unit 3B of the vehicle control device 14 of the second embodiment does not include the radar.

In an example of the second embodiment, as the limit detection distance of the learning surrounding situation sensor L11, the distance between the learning vehicle L1 and the preceding vehicle calculated from the sensor data (image of the front of the learning vehicle L1 shot by the learning camera) of the learning surrounding situation sensor L11 before (in some embodiments, immediately before) the state switches from the state (detectable state) in which the learning surrounding situation sensor L11 can detect the preceding vehicle of the learning vehicle L1 based on the sensor data of the learning surrounding situation sensor L11 to the state (undetectable state) in which the learning surrounding situation sensor L11 cannot detect the preceding vehicle of the learning vehicle L1 based on the sensor data of the learning surrounding situation sensor L11 is used.

In another example of the second embodiment, as the limit detection distance of the learning surrounding situation sensor L11, the distance between the learning vehicle L1 and the preceding vehicle calculated from the sensor data of the learning surrounding situation sensor L11 after (in some embodiments, immediately after) the state switches from the state (undetectable state) in which the learning surrounding situation sensor L11 cannot detect the preceding vehicle of the learning vehicle L1 based on the sensor data of the learning surrounding situation sensor L11 to the state (detectable state) in which the learning surrounding situation sensor L11 can detect the preceding vehicle of the learning vehicle L1 based on the sensor data of the learning surrounding situation sensor L11 is used.

In other words, in the second embodiment, the distance between the learning vehicle L1 and the preceding vehicle of the learning vehicle L1 calculated based on the image (for example, image including a base point sign of a vehicle-to-vehicle distance confirmation section or the like) of the front of the learning vehicle L1 shot by the learning camera before or after the state switches between the detectable state and the undetectable state is used as the limit detection distance of the learning surrounding situation sensor L11.

In the second embodiment, the inference unit 3B infers the limit detection distance of the surrounding situation sensor 11 based on the sensor data (image of the front of the host vehicle 1 shot by the camera) of the surrounding situation sensor 11 by using the machine learning model obtained by performing the learning using the data set (teacher data) of the image of the front of the learning vehicle L1 shot by the learning camera when the state switches between the detectable state and the undetectable state, and the distance between the learning vehicle L1 and the preceding vehicle (limit detection distance of the learning surrounding situation sensor L11) calculated based on the image of the front of the learning vehicle L1 shot by the learning camera before or after the state switches between the detectable state and the undetectable state.

In the host vehicle 1 to which the vehicle control device 14 of the second embodiment is applied, it is possible to suppress the possibility that the control of the host vehicle 1 is inappropriately performed when the limit detection distance of the surrounding situation sensor 11 is short (when the surrounding situation sensor 11 cannot detect the preceding vehicle of the host vehicle 1 due to bad weather or the like).

### Third Embodiment

The host vehicle 1 to which the vehicle control device 14 of a third embodiment is applied is configured similarly to the vehicle 1 to which the vehicle control device 14 of the first embodiment shown in FIG. 1, except for the points mentioned below. The learning vehicle L1 used to obtain the machine learning model used for the inference of the limit detection distance by the inference unit 3B of the vehicle control device 14 of the third embodiment is configured similarly to the learning vehicle L1 shown in FIG. 2, except for the points mentioned below.

As described above, in the host vehicle 1 to which the vehicle control device 14 of the first embodiment is applied, the surrounding situation sensor 11 includes the camera which shoots the front of the host vehicle 1. In the first embodiment, the learning surrounding situation sensor L11 includes the learning camera which shoots the front of the learning vehicle L1.

On the other hand, in the host vehicle 1 to which the vehicle control device 14 of the third embodiment is applied, the surrounding situation sensor 11 includes a LIDAR (Light Detection And Ranging) which detects the distance between the host vehicle 1 and the preceding vehicle of the host vehicle 1 or the like. In the third embodiment, the learning surrounding situation sensor L11 includes a learning LiDAR which detects the distance between the learning vehicle L1 and the preceding vehicle of the learning vehicle L1 or the like.

As described above, in the first embodiment, the image of the front of the host vehicle 1 shot by the camera is used as the sensor data of the surrounding situation sensor 11, and the image of the front of the learning vehicle L1 shot by the learning camera is used as the sensor data of the learning surrounding situation sensor L11.

On the other hand, in the third embodiment, the sensor data (for example, reflected light intensity, detection point cloud, or the like) of the LiDAR is used as the sensor data of the surrounding situation sensor 11, and the sensor data (for example, reflected light intensity, detection point cloud, or the like) of the learning LiDAR is used as the sensor data of the learning surrounding situation sensor L11. In the third embodiment, the state in which the learning surrounding situation sensor L11 cannot detect the preceding vehicle of the learning vehicle L1 based on the sensor data of the learning surrounding situation sensor L11 includes a state in which the difference between the distance between the learning vehicle L1 and the preceding vehicle calculated based on the sensor data of the learning LiDAR and the distance between the learning vehicle L1 and the preceding vehicle calculated based on the sensor data of the radar L12 is greater than or equal to a predetermined threshold.

### Fourth Embodiment

The host vehicle 1 to which the vehicle control device 14 of a fourth embodiment is applied is configured similarly to the host vehicle 1 to which the vehicle control device 14 of the third embodiment described above is applied. The learning vehicle L1 used to obtain the machine learning model used for the inference of the limit detection distance by the inference unit 3B of the vehicle control device 14 of the third embodiment includes the radar L12. On the other hand, the learning vehicle L1 used to obtain the machine learning model used for the inference of the limit detection distance by the inference unit 3B of the vehicle control device 14 of the fourth embodiment does not include the radar.

In an example of the fourth embodiment, as the limit detection distance of the learning surrounding situation sensor L11, the distance between the learning vehicle L1 and the preceding vehicle of the learning vehicle L1 calculated from the sensor data of the learning surrounding situation sensor L11 (learning LiDAR) before (in some embodiments, immediately before) the state switches from the state (detectable state) in which the learning surrounding situation sensor L11 can detect the preceding vehicle of the learning vehicle L1 based on the sensor data of the learning surrounding situation sensor L11 to the state (undetectable state) in which the learning surrounding situation sensor L11 cannot detect the preceding vehicle of the learning vehicle L1 based on the sensor data of the learning surrounding situation sensor L11 is used.

In another example of the fourth embodiment, as the limit detection distance of the learning surrounding situation sensor L11, the distance between the learning vehicle L1 and the preceding vehicle of the learning vehicle L1 calculated from the sensor data of the learning surrounding situation sensor L11 (learning LiDAR) after (in some embodiments, immediately after) the state switches from the state (undetectable state) in which the learning surrounding situation sensor L11 cannot detect the preceding vehicle of the learning vehicle L1 based on the sensor data of the learning surrounding situation sensor L11 to the state (detectable state) in which the learning surrounding situation sensor L11 can detect the preceding vehicle of the learning vehicle L1 based on the sensor data of the learning surrounding situation sensor L11 is used.

In other words, in the fourth embodiment, the limit detection distance between the learning vehicle L1 and the preceding vehicle of the learning vehicle L1 calculated based on the sensor data of the learning surrounding situation sensor L11 (learning LiDAR) before or after the state switches between the detectable state and the undetectable state is used as the limit detection distance of the learning surrounding situation sensor L11.

In the fourth embodiment, the inference unit 3B infers the limit detection distance of the surrounding situation sensor 11 (LIDAR) based on the sensor data of the surrounding situation sensor 11 by using the machine learning model obtained by performing the learning using the data set (teacher data) of the sensor data of the learning surrounding situation sensor L11 (learning LiDAR) when the state switches between the detectable state and the undetectable state, and the distance between the learning vehicle L1 and the preceding vehicle (limit detection distance of the learning surrounding situation sensor L11) calculated based on the sensor data of the learning surrounding situation sensor L11 before or after the state switches between the detectable state and the undetectable state.

As described above, although the embodiments of the vehicle control device, the vehicle control method, and the non-transitory recording medium of the present disclosure have been described with reference to the drawings, the vehicle control device, the vehicle control method, and the non-transitory recording medium of the present disclosure are not limited to the embodiments described above, and may be appropriately changed without departing from the scope of the present disclosure. The configuration of each example of the embodiment described above may be appropriately combined. In each example of the above-described embodiment, the process performed in the vehicle control device 14 has been described as software process performed by executing the program, but the process performed in the vehicle control device 14 may be process performed by hardware. Alternatively, the process performed by the vehicle control device 14 may be a combination of both software and hardware. Further, the program (program for realizing the function of the processor 143 of the vehicle control device 14) stored in the memory 142 of the vehicle control device 14 may be recorded in a computer-readable storage medium (non-transitory recording medium) such as, semiconductor memory, magnetic recording medium, optical recording medium, or the like for providing, distribution or the like.

1. A vehicle control device comprising a processor configured to:
infer a limit detection distance which is a maximum value of a distance from a surrounding situation sensor detectable by the surrounding situation sensor, the surrounding situation sensor being mounted on a host vehicle,
wherein the processor is configured to infer the limit detection distance of the surrounding situation sensor based on sensor data of the surrounding situation sensor by using a machine learning model obtained by performing learning using teacher data which is a data set of sensor data of a learning surrounding situation sensor mounted on a learning vehicle and a label indicating the limit detection distance of the learning surrounding situation sensor when the sensor data of the learning surrounding situation sensor is obtained.

2. The vehicle control device according to claim 1, wherein a distance between the learning vehicle and a preceding vehicle of the learning vehicle detected by a radar mounted on the learning vehicle when a state switches between a state in which the preceding vehicle can be detected based on the sensor data of the learning surrounding situation sensor and a state in which the preceding vehicle cannot be detected based on the sensor data of the learning surrounding situation sensor is used as the limit detection distance of the learning surrounding situation sensor.

3. The vehicle control device according to claim 1, wherein the processor is configured to set maximum speed limit of the host vehicle while performing driving assistance of the host vehicle,
the processor is configured to assume that the distance between the preceding vehicle of the host vehicle and the host vehicle is approximately equal to the limit detection distance of the surrounding situation sensor and set a speed at which the host vehicle can follow the preceding vehicle as the maximum speed limit when the limit detection distance of the surrounding situation sensor is less than or equal to a threshold value.

4. A vehicle control method comprising:
inferring a limit detection distance which is a maximum value of a distance from a surrounding situation sensor detectable by the surrounding situation sensor, the surrounding situation sensor being mounted on a host vehicle,
wherein the limit detection distance of the surrounding situation sensor is inferred based on sensor data of the surrounding situation sensor by using a machine learning model obtained by performing learning using teacher data which is a data set of sensor data of a learning surrounding situation sensor mounted on a learning vehicle and a label indicating the limit detection distance of the learning surrounding situation sensor when the sensor data of the learning surrounding situation sensor is obtained.

5. A non-transitory recording medium having recorded thereon a computer program for causing a processor to perform a process comprising:
inferring a limit detection distance which is a maximum value of a distance from a surrounding situation sensor detectable by the surrounding situation sensor, the surrounding situation sensor being mounted on a host vehicle,
wherein the limit detection distance of the surrounding situation sensor is inferred based on sensor data of the surrounding situation sensor by using a machine learning model obtained by performing learning using teacher data which is a data set of sensor data of a learning surrounding situation sensor mounted on a learning vehicle and a label indicating the limit detection distance of the learning surrounding situation sensor when the sensor data of the learning surrounding situation sensor is obtained.
